(19) United States
(12) Patent Application Publication
(10) Pub. No.: US 2011/0037704 A1
(43) Pub. Date: Feb. 17, 2011

(54) FLASH LIGHTING INPUT APPARATUS AND DRIVING METHOD THEREFOR

(76) Inventor: Allen Ku, Walnut, CA (US)

Correspondence Address: NIKOLAI & MERSEREAU, P.A., 900 SECOND AVENUE SOUTH, SUITE 820, MINNEAPOLIS, MN, 55402, US

(21) Appl. No.: 12/541,382

(22) Filed: Aug. 14, 2009

(51) Int. Cl. G06F 3/02

(52) U.S. Cl. 345/170

(57) ABSTRACT

This invention provides a flash lighting input apparatus and driving method. According to this invention, the flash lighting input apparatus can be a flash lighting keyboard. The flash lighting apparatus comprises a micro control unit, a pulse width modulation unit electrically connects to the micro control unit, a light control unit electrically connects to the pulse width modulation unit, and a lighting unit electrically connects to the light control unit. The micro control unit produces a control signal to the pulse width modulation unit, and the pulse width modulation unit produces a modulation signal according to the control signal. The lighting control unit receives the modulation signal and produces a driving signal according to the modulation signal, and transfers the driving signal to the lighting unit to drive the lighting unit.

### BACKGROUND OF THE INVENTION

1. Field of the Invention

The present invention relates to a power saving input apparatus with flash lighting, more specifically relates to a lighting keyboard functioned with a pulse width modulation method.

2. Description of Related Art

With the popularity of high-tech products and functional diversification, the importance of the input apparatus becomes higher. There are many existed new-type input methods such as touch panel input, stylus input, the speech recognition and the like. However, the traditional input tools, such as keyboard and mouse, are still the most acceptable to the public and difficult to be replaced.

Since users use these input apparatuses in different situations, for example, the keyboard is used in low ambient lighting or in the dark, and the keyboard keypads are difficult to be recognized. Therefore, to the way to make these input apparatuses clearly recognized in such situations becomes an important direction of development.

FIG. 1 is a schematic view illustrating the structure of a lighting keyboard in a prior art.

Lighting keyboard includes a keypad component 110, and a thin film circuit board 120, an insulator film 130, a lighting element 140, a light guide plate 145 and a bottom plate 150 are installed under the keypad component 110 sequentially to compose the lighting keyboard. A plurality of transparent keycaps 115 installed on the keypad device 110, so that a back light can pass through. Wherein, the combination of the lighting element 140 and light guide plate 145 can be replaced by an electro-luminescence device, or a backlight module, and the lighting element 140 can be a LED array, CCFL or the like.

A plurality of keypad input points 125 are arranged on the thin film circuit board 120, and the keypad input points 125 are one-by-one arrayed on those transparent keycaps 115. In which, there are two touch points arranged under these keypad input points 125 and two open circuit points are above the thin film circuit board 120. When a user clicks one of the transparent keycaps 115, the two touch points conduct the open circuit point. Meanwhile, a keystroke signal is generated and transferred to a micro control unit of the lighting keyboard. Then the lighting keyboard identifies the key signal, and the input signal of the user inputs can be recognized.

FIG. 2 is a schematic view illustrating the driving module of a lighting keyboard of a prior art.

The micro control unit 210 receives keystroke signals, and sends out the keystroke signals. Micro control unit 210 electrically connects to the light control unit 230 and the micro control unit 210 provides a control signal to controlling the light control unit 230. Light control unit 230 receives the control signal and provides a driving signal to lighting element 240 for driving a lighting element 240. The lighting element 240 is similar with the lighting element 140 shown in FIG. 1.

With the environmental awareness raises in recent years, the concept of energy saving has become a main requirement of high-tech products. The above-mentioned lighting keyboard always keeps in lighting condition, even if the user does not use the keyboard nor needs not the lighting function. Therefore, the conventional lighting keyboard wastes the energy.

### SUMMARY OF THE INVENTION

According to the present invention, a flash lighting keyboard driving module is provided. The module has a micro control unit for producing a control signal, a pulse width modulation unit electrically connected to the micro control unit for receiving the control signal of the micro control unit, and further producing a modulation signal according to the control signal, and a light control unit connected to the pulse width modulation unit for receiving the modulation signal of the pulse width modulation unit, and producing a driving signal according to the modulation signal in order to drive a lighting element.

According to another embodiment of present invention, a flash lighting keyboard is provided. The keyboard has a keypad device and a thin film circuit board. A lighting element, a light guide plate, and a bottom plate are sequentially disposed under the keypad device. A micro control unit is further included to produce a control signal. A pulse width modulation unit electrically connected to the micro control unit is also included for receiving the control signal of the micro control unit, and producing a modulation signal according to the control signal. A light control unit electrically connected to the pulse width modulation unit is provided to receive the modulation signal of the pulse width modulation unit, and produce a driving signal to drive the lighting element according to the modulation signal. A timing unit positioned in the micro control unit is further included to produce a first timing signal and a second timing signal.

According to the embodiment of the present invention, a flash lighting keyboard is provided. The claimed keyboard has a counting unit in the micro control unit. The counting unit sends a first time signal according to a first setting time. A pulse width modulation unit is provided to produce a modulation signal with lower duty cycle according to the first time signal. The counting unit sends a second time signal according to a second setting time, and the pulse width modulation unit produces a modulation signal with 0 duty cycle according to the second time signal. In particular, the second setting time is larger than the first setting time.

### BRIEF DESCRIPTION OF THE DRAWINGS

FIG. 1 is a schematic view illustrating the structure of a lighting keyboard of a prior art;

FIG. 2 is a schematic view illustrating the driving module of a lighting keyboard of a prior art;

FIG. 3 is a schematic view illustrating the driving module of the flash lighting keyboard according to the embodiment of the present invention;

FIGS. 4A, 4B and 4C illustrate the wave form of the pulse width modulation signal with different duty cycle ratio in the present invention;

FIG. 5 illustrates the driving module of the flash lighting keyboard using the pulse width modulation method according to another embodiment of the present invention;

FIG. 6 is a schematic view illustrating the structure of flash lighting keyboard according to the other embodiment of present invention;

FIG. 7 is a schematic view illustrating the structure of flash lighting keyboard with photo detecting function according to the other embodiment of present invention;

FIG. 8 illustrates the driving module of the flash lighting keyboard with photo detecting unit and using the pulse width modulation method according to another embodiment of the present invention.

### DETAILED DESCRIPTION OF THE PREFERRED EMBODIMENTS

FIG. 3 is a schematic view illustrating the driving module of the flash lighting keyboard according to the embodiment of the present invention.

A micro control unit 210 electrically connects to a pulse width modulation unit 320, and the pulse width modulation unit 320 electrically connects to a light control unit 230. The light control unit 230 connects to the lighting elements 240.

The micro control unit 210 provides a control signal to pulse width modulation unit 320 to control pulse width modulation unit 320. The pulse width modulation unit 320 generates a modulation signal according to the control signal. The light control unit 230 generates a driving signal according to the modulation signal, and provides the driving signal to the lighting element 240 to drive the lighting element 240 and lights the lighting element 240.

Further, the pulse width modulation unit 320 produces a modulation signal with a fixed operation frequency and a fixed duty cycle ratio by a pulse width modulation method according to the control signal produced by the micro control unit 210.

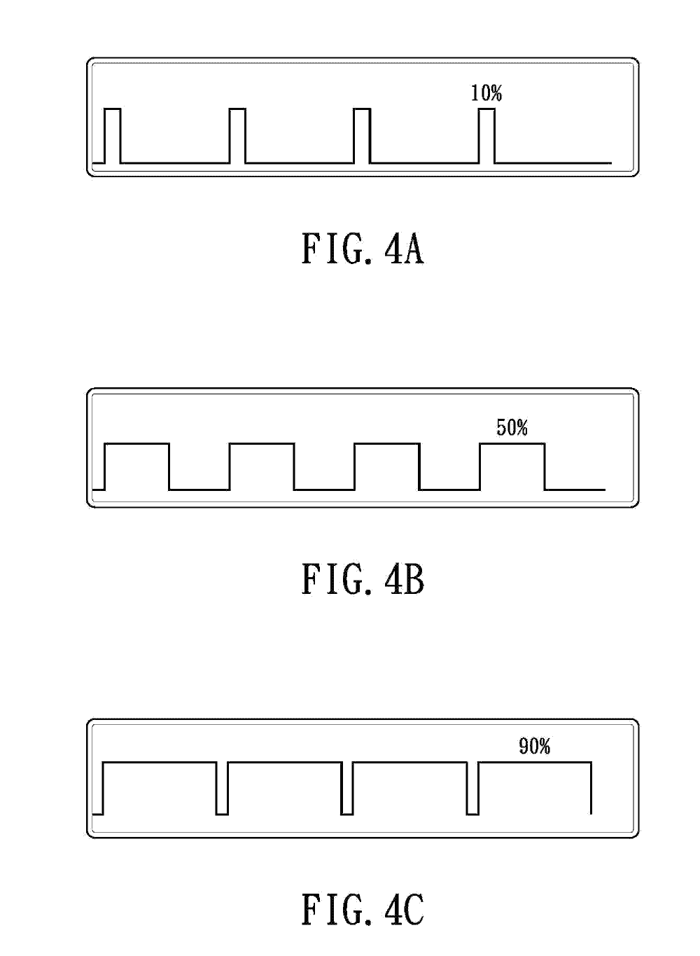

FIGS. 4A, 4B and 4C are illustrating the wave form of the pulse width modulation signal with different duty cycle ratio.

FIG. 4A is illustrating the wave form of modulation signal with 10% duty cycle ratio. When the modulation signal is inputted from the pulse width modulation unit 320 to the light control unit 230, the light control unit 230 produces a driving signal having the same operation frequency and 10% duty cycle ratio according to the modulation signal, and outputting the driving signal to the lighting element 240. It means that the driving signal drives the lighting element 240 in 10% of one cycle time in a fixed operation frequency, and deactivates the lighting element 240 in rest of 90% of one cycle time. Therefore, the pulse width modulation unit saves 90% power consumption than the conventional DC consumed to drive the lighting element 240.

FIG. 4B and FIG. 4C is illustrating the wave form of modulation signal with 50% and 90% duty cycle ratio. The operation method is the same with previous description, and saving 50% or a 10% power consumption than the DC used for driving the lighting element 240.

Therefore, the present invention uses this pulse width modulation method to provide a modulation signal with 10% to 90% of the duty cycle ratio, hence, the flash lighting keyboard of the present invention saves 90% to 10% power consumption. More, the flash lighting keyboard also operates within 0% to 100% duty cycle ratio. However, the present invention is not limited by the above description.

The modulation signal of the pulse width modulation unit 320 according to the present invention is generally operating in the frequency beyond 25 Hz, which makes people not distinguishing the flashing. The preferred operation frequency is ranged between 150 Hz to 250 Hz. The higher operation frequency can make human eyes ignoring feeling the flash lighting in various luminous intensities of ambient light. However the operation frequency of the present invention is not limited by the above description.

In this embodiment of present invention, the micro control unit 210 of flash lighting keyboard sends the control signal to the pulse width modulation unit 320. The pulse width modulation unit 320 produces a modulation signal according to the control signal. The light control unit 230 produces a driving signal according to the modulation signal and sends the driving signal to the lighting element 240 to drive the lighting element 240, wherein the driving signal has the same operation frequency and duty cycle with the modulation signal.

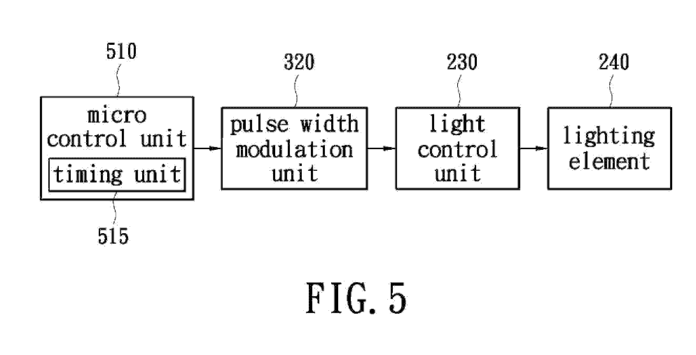

FIG. 5 is illustrating the driving module of the flash lighting keyboard using the pulse width modulation method according to another embodiment of the present invention.

The driving module of FIG. 5 is similar with the one shown in FIG. 3. The difference therebetween is that the micro control unit 510 (FIG. 5) of the flash lighting keyboard has a timing unit 515, and the timing unit 515 begins to count the time when the flash lighting keyboard does not detect any input signal from a user's operation.

If the micro control unit 510 does not detect the input signal from a user's input, the timing unit 515 begins to count the time. When the counting time accumulates to a first setting time, the timing unit 515 of the micro control unit 510 sends a first timing signal to the pulse width modulation unit 320 by the micro control unit 510. The pulse width modulation unit 320 produces a modulation signal according to the first timing signal, and sends the modulation signal to the light control unit 230. At the moment, the modulation signal has lower duty cycle ratio than the duty cycle ratio in a normal operation. The light control unit 230 produces a driving signal according to the modulation signal, and the driving signal having the same operation frequency and duty cycle ratio with the modulation signal. Therefore, the flash lighting keyboard can reduce the brightness of lighting and save the power consumption.

If the micro control unit 510 does not detect the input signal from a user's input, the timing unit 515 begins to count the time. When the counting time accumulates to the second setting time, the timing unit 515 of the micro control unit 510 sends a second timing signal to the pulse width modulation unit 320 by the micro control unit 510. The pulse width modulation unit 320 produces a modulation signal according to the second timing signal, and sends the modulation signal to the light control unit 230. In this time, the modulation signal has lowest duty cycle ratio. Further, the light control unit 230 produces a driving signal with the lowest duty cycle ratio according to the modulation signal. In this embodiment, the lighting element 240 is deactivated to light the flash lighting keyboard so as to stop consuming power until the flash lighting keyboard detects the input signal again.

Wherein, the second setting time is larger than the first setting time. That is, the flash lighting keyboard adjusts the lighting brightness in advance so as to reduce the power consumption when a user not yet uses the keyboard in a first setting time. At the moment, the flash lighting keyboard stops lighting element 240 so as to save power consumption since the user does not use the keyboard in a second setting time.

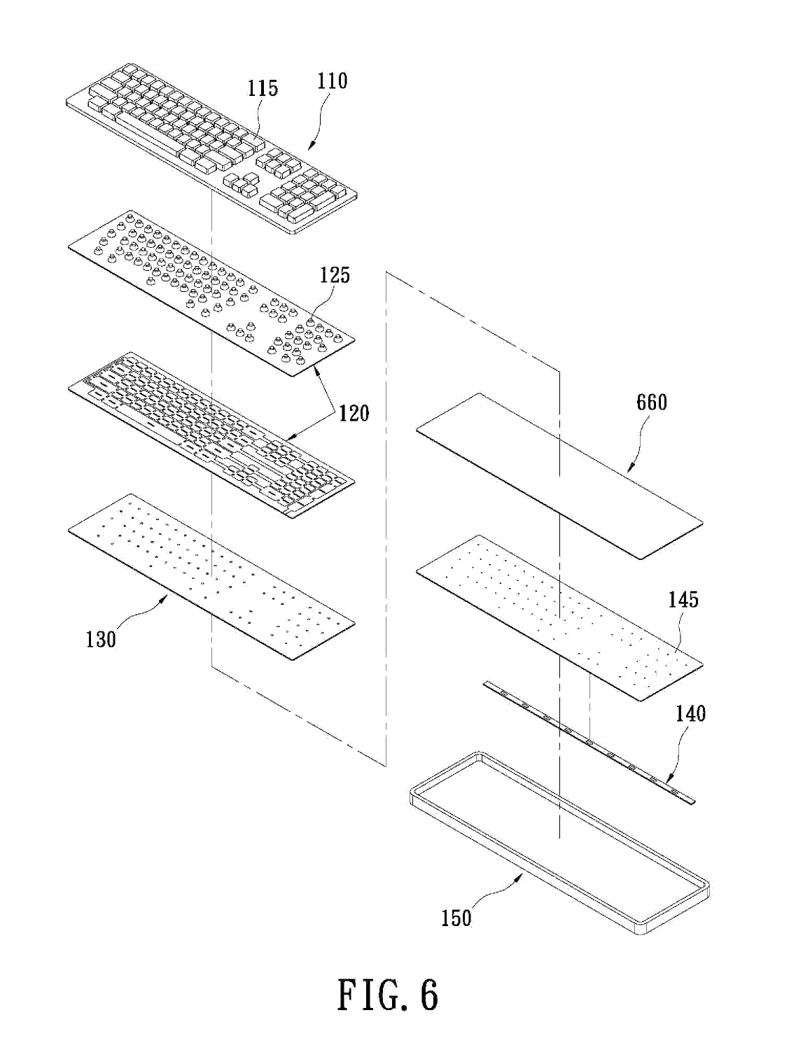

FIG. 6 is a schematic view illustrating the structure of flash lighting keyboard according to the other embodiment of present invention.

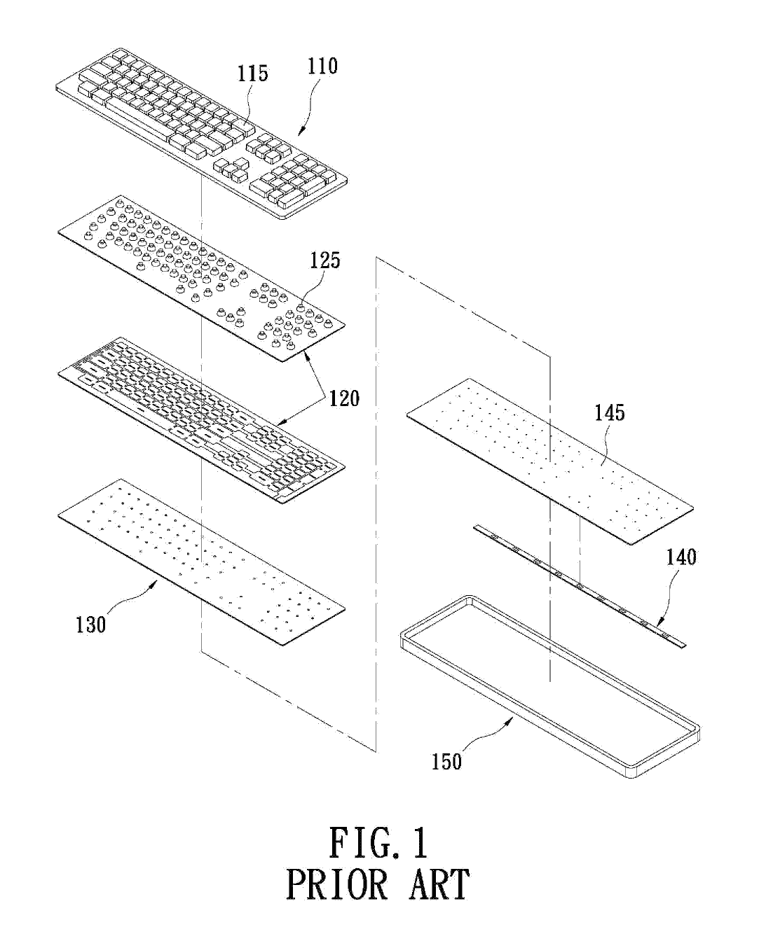

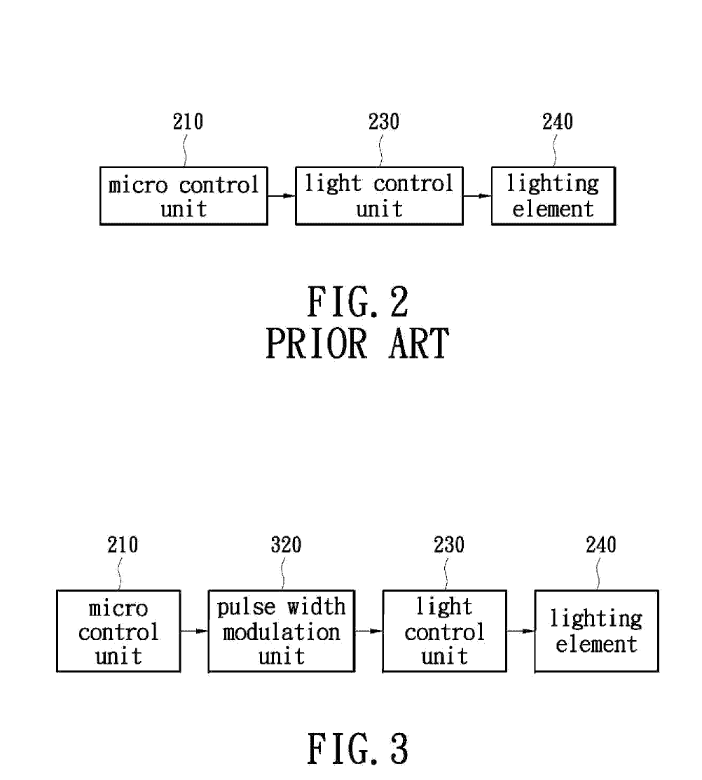

The structure shown in FIG. 6 is similar with the structure shown in FIG. 1. The difference generally is that a fluorescent layer 660 is coated on the light guide plate 145 in FIG. 6. Wherein, the material of the fluorescent layer 660 preferably uses organic fluorescent powder, fluorescent pigments or inorganic fluorescent powder. The bottom plate 150 can reflects leakage light from the lighting element 140 to light guide plates 145. Wherein, the material of the bottom plate 150 can be aluminum or silver mirror. However the present invention is not limited by the above description.

When the lighting element 140 starts to light, the fluorescent layer 660 coated on the light guide plate 145 absorbs the light of the lighting element 140.

The fluorescent layer 660 starts to light under a close state of the duty cycle of the modulation driving signal. Hence it's to compensate the decrease of brightness of the flash lighting keyboard which uses pulse width modulation method. Further, when the pulse width modulation unit 320 adjusts the duty cycle ratio to 0%, the fluorescent layer 660 still keeps in lighting.

In the present invention, the fluorescent layer 660 can also be coated on the key cap 115. However, the position of the being coated of the fluorescent layer 660 in the present invention is not limited.

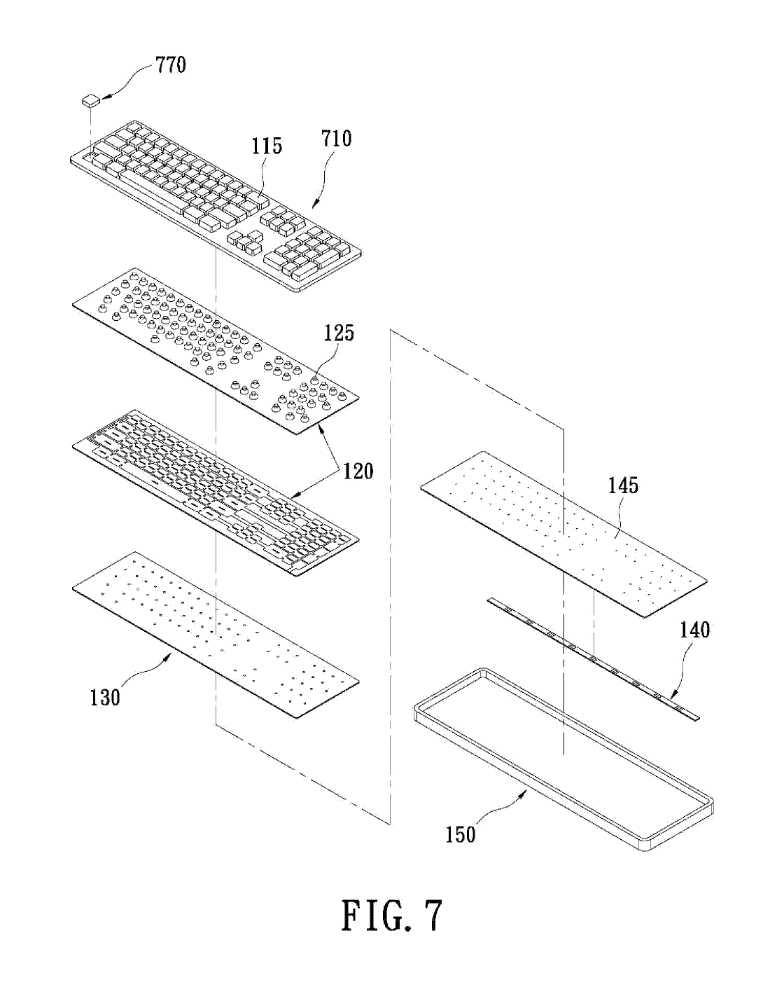

FIG. 7 is a schematic view illustrating the structure of flash lighting keyboard with photo detecting function according to the further embodiment of present invention.

The structure shown in FIG. 7 is similar with the structure shown in FIG. 1. The difference is generally that a photo detecting unit 770 in FIG. 7 is installed on a keypad device 710. Wherein, the photo detecting unit 770 can be a photo detector or a photo resistor. However, the present invention is not limited by this embodiment.

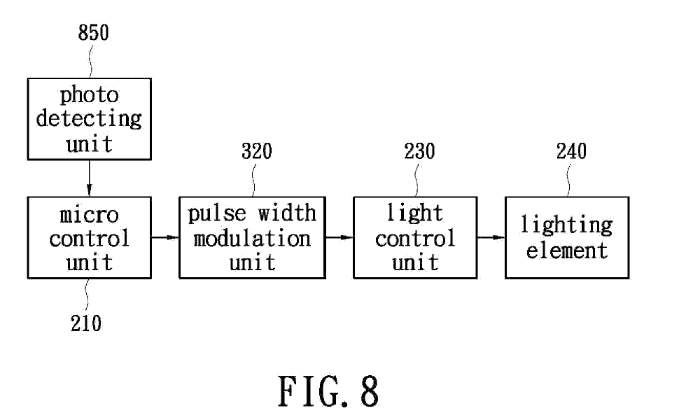

FIG. 8 is illustrating the driving module of the flash lighting keyboard with photo detecting unit and using the pulse width modulation method according to another embodiment of the present invention.

The driving module shown in FIG. 8 is similar with FIG. 3. There is a photo detecting unit 850 which is the same with the photo detecting unit 770 shown in FIG. 7. The photo detecting unit 850 electrically connects to the micro control unit 210. The photo detecting unit 850 detects the brightness of the ambient light, and produces a photo detecting signal and sends to the micro control unit 210.

When the light detecting unit 850 produces a photo detecting signal, the micro control unit 210 produces a control signal according to the photo detecting signal, the pulse width modulation unit 320 produces a modulation signal according to the control signal. The light control unit 230 further produces a driving signal according to the modulation signal, and sends the driving signal to the lighting element 240.

In particular, the stronger the ambient light intensity is, the stronger photo detecting signal strength is. The pulse width modulation unit 320 produces a lower duty cycle ratio modulation signal according to the stronger photo detecting signal strength, and vice versa. Therefore, the present invention can adjust the duty cycle ratio of the lighting element 240 followed by the ambient light intensity of the light detecting unit 850.

What is claimed is:

1. A flash lighting keyboard driving module, comprising:
a micro control unit producing a control signal;
a pulse width modulation unit electrically connecting to the micro control unit and receiving the control signal of the micro control unit, and producing a modulation signal according to the control signal; and
a light control unit connecting to the pulse width modulation unit and receiving the modulation signal of the pulse width modulation unit, and producing a driving signal according to the modulation signal to drive a lighting element.

2. The driving module of claim 1, wherein the modulation signal produced by pulse width modulation unit has an operation frequency and a duty cycle.

3. The driving module of claim 2, wherein the operation frequency is above 25 Hz.

4. The driving module of claim 2, wherein the duty cycle ratio is ranged from 10% to 90%.

5. The driving module of claim 1, further comprising an keypad device, a thin film circuit board, the lighting element, a light guide plate and a bottom plate, wherein the lighting element and the light guide plate are disposed under the thin film circuit board and provides light to the keypad device, and a plurality of transparent keycaps are installed on the keypad device.

6. The driving module of claim 1, further comprising a timing unit disposed in the micro control unit.

7. The driving module of claim 6, wherein the timing unit sends a first timing signal according to a first setting time, and sends a second timing signal according to a second setting time.

8. The driving module of claim 7, wherein the pulse width modulation unit produces a modulation signal with lower duty cycle ratio compared with the normal duty cycle ratio according to the first timing signal, and produces a modulation signal with 0% duty cycle ratio according to the second timing signal.

9. The driving module of claim 8, wherein the second setting time is larger than the first setting time.

10. The driving module of claim 5, further comprising a fluorescent layer coated on the light guide plate.

11. The driving module of claim 5, further comprising a fluorescent layer coated on the keycap of the keypad device.

12. The driving module of claim 1, further comprising a photo detecting unit electrically connected to the micro control unit.

13. The driving module of claim 12, wherein the photo detecting unit detects an ambient light intensity and produces a photo detecting signal.

14. The driving module of claim 13, wherein the micro control unit produces a control signal according to the photo detecting signal, and the pulse width modulation produces a modulation signal according to the control signal.

15. The driving module of claim 14, the flash lighting keyboard adjusts the brightness of the lighting element by the photo detecting unit.

16. A flash lighting keyboard, comprising:
a keypad device, and a thin film circuit board, a combination of a lighting element and a light guide plate, and a bottom plate sequentially positioned under the keypad device;
a micro control unit producing a control signal;
a pulse width modulation unit electrically connecting to the micro control unit and receiving the control signal of the micro control unit, and producing a modulation signal according to the control signal;
a light control unit electrically connecting to the pulse width modulation unit and receiving the modulation signal of the pulse width modulation unit, and producing a driving signal to drives the lighting element according to the modulation signal; and
a timing unit disposed in the micro control unit producing a first timing signal and a second timing signal.

17. The flash lighting keyboard of claim 16, wherein the timing unit sends a first timing signal according to a first setting time, and sends a second timing signal according to a second setting time.

18. The flash lighting keyboard of claim 17, wherein the pulse width modulation unit produces a modulation signal with lower duty cycle ratio than normal duty cycle ratio according to the first timing signal, and produces a modulation signal with 0% duty cycle ratio according to the second timing signal.

19. The flash lighting keyboard of claim 18, wherein the second setting time is larger than the first setting time.
